(19) United States
(12) Patent Application Publication
(10) Pub. No.: US 2009/0313166 A1
(43) Pub. Date: Dec. 17, 2009

(54) METHOD AND SYSTEM FOR FACILITATING FUNDRAISING VIA A COMMUNICATION NETWORK

(76) Inventor: Cornelius McNab, Riverdale, GA (US)

Correspondence Address: John Doughty, 42 Creekside Court, Acworth, GA, 30101, US

(21) Appl. No.: 12/484,411

(22) Filed: Jun. 15, 2009

Related U.S. Application Data
(60) Provisional application No. 61/061,590, filed on Jun. 13, 2008.

(51) Int. Cl. G06Q 40/00

(52) U.S. Cl. 705/42; 705/39

(57) ABSTRACT

A funding facilitator hosts a web site that allows an entity seeking funding to create a funding request and either forward the request to preselected individuals, or entities, or make the request publicly available. If a potential funder wishes to contribute, it establishes an account and login credentials with the funding facilitator and authorizes a transfer of funds from its account to a payment processor account associated with a fundee at the funding facilitator. The funding facilitator receives information from the payment processor related to the fundee's transactions, and makes the information available to respective funders that enter their already-established login credentials through the hosted web site. The funding facilitator initiates repayments to funders who are lenders according to a repayment schedule and to proportions that they contributed to the funding amount. The repayment schedule may also reflect interest.

### CROSS REFERENCE TO RELATED APPLICATION

This application claims priority under 35 U.S.C. 119(e) to U.S. provisional patent application No. 61/061,590 entitled “Method for the facilitation and management of fundraising between peers, friends, and relatives via the internet,” which was filed Jun. 13, 2008, and is incorporated herein by reference in its entirety.

### FIELD

The present invention relates to a method for the facilitation and management of fundraising through peers, family, and friends.

### BACKGROUND

Raising funds from one's friends, family, and peers can be a daunting challenge, whether you're an entrepreneur raising capital for a startup business, a student raising money for school, an organization raising charitable donations, or an individual seeking a personal consumer loan. How do you facilitate multiple fundraising requests and manage multiple funders (i.e., those who provide funds, such as investors, donors, and lenders) in a structured and scalable way? How do you give potential funders peace-of-mind and increase their trust so that they are more willing to provide you the money you need?

In the world of startup and early stage entrepreneurs, obtaining funding for their business venture often presents a challenge. When many of them have difficulty securing funds through traditional bank loans, they opt for using personal funds, financing through credit card debt or a second mortgage, and often as a last resort, borrow from family and friends. In many cases, small businesses fail due to lack of or inadequate funding.

There is a well known saying, “never borrow or lend to family or friends” because it will ruin your relationship. As true as this statement may sometimes be, funding businesses and other projects through family and friends takes place every day. Many highly successful business people refer back to how they got started with a small loan from their family and/or friends. Notwithstanding the commonness and effectiveness of this informal process, it still lacks structure and scalability that would make it more effective and accessible.

In today's tight credit market, it is even more difficult for entrepreneurs and other fundees (i.e. those raising and receiving the funds, such as founders, fundraisers, and borrowers) to get funding through traditional channels.

Adding to the problem of scarcity of credit sources today is the absence of effective communication between the funder and fundee (e.g. between an investor and an entrepreneur) in their relationship. This integral aspect of the communication link between the two parties is needed to first establish the relationship and later to maintain it. In most cases, the funder(s), who provides the funding to the fundee, is not always given information during the life cycle of the business or project regarding how the funds are being utilized. There is a lack of transparency. When things go bad, they are often not dealt with between the parties until the situation is too far gone to recover.

In the realm of unsecured loans, the importance of communication between the borrower and lender is even more essential when facilitating loans of this type. Usually, unsecured loans are not readily available as most large financial institutions are unwilling to partake in the risk involved. However, often for entrepreneurs, these are the loans most vital to the creation and growth of their small businesses. To fill this void, smaller entities including family and friends of the borrower become the primary source for funding. For these friends-and-family lenders, constant communication throughout the loan process, from start through repayment, can provide a substitute for the collateral that a borrower (e.g. a startup entrepreneur or a college student) may not be able to provide.

### SUMMARY

An aspect uses a communication network, the Internet, for example, to help a fundee raise the money by facilitating communication between the parties and for executing documents and transferring funds. In addition, the fundee may use a bank account and funding identifier to manage and track the movement of funds in a transaction. An aspect provides a funder with on-line access to information regarding how and when the money provided to the fundee is being spent. Also, an aspect facilitates a “one to many” lending arrangement by managing repayments of various loans with multiple loan features through one easy payment mechanism.

An aspect facilitates fundraising through three possible mechanisms: donation, loan, and equity investment. Fundraising for a given fundee may use any combination of one, or more, of these mechanisms.

In all the embodiments described below, it is to be understood that the invention is capable of accommodating potentially multiple funders and fundees involved in a single transaction.

In an embodiment, the funder, or funders and fundee may form different funding relationships. The possible relationships that can arise from the transaction between the parties include: a donor making a donation or gift, a lender providing a loan to be repaid, and an investor providing funds in exchange for entity ownership or company equity (shares, stock).

At least one embodiment allows for a funding relationship between potentially multiple funders and a single fundee or multiple fundees and a single funder where there is accountability to and trackability by the funder(s). A facilitating entity (e.g. a website) utilizes the invention and its management structure which create an opportunity for the parties to communicate in establishing the relationship and later maintaining it. The management structure of the invention utilizes a financial mechanism (i.e. an electronically based financial network, including, but not limited to internet based networks) with an identifier (funding ID) to track all outgoing funds. The financial mechanism consists of any entity which can be used to communicate the transfer and maintain trackability of funds involved in the transaction. For example, the financial mechanism can include networks that are accessed even by cell/mobile phone. The financial mechanism is issued by the management structure of the invention increasing the efficiency of the relationship between the fundee(s) and funder(s). The management structure of the invention makes the funds accessible to the fundee via the financial mechanism. The financial mechanism is issued to the fundee under the management structure of the invention. The funder(s) can electronically track funds disbursed through the financial mechanism to ensure fundee's accountability. In this same context, the management structure enables the fundee to make multiple loan repayments to several funders as part of the same loan (“microlending”) and in a single electronic transaction.

In another embodiment, the facilitating entity (this is the entity in the framework which is the hub for communications and instruction for the management structure created by the present invention) integrates and communicates with an online payment processor, such as an online bank or merchant account provider, which transfers funds between various banks and accounts. The accounts include the bank accounts of the funder(s), the fundee(s), and the facilitating entity. The facilitating entity facilitates communications and electronic fund transfers between the funder(s), the fundee(s), the online payment processor and the banks involved. In this embodiment, communications and instructions from the facilitating entity related to the fund transfers between the funder and fundee (either for disbursement or repayment) are sent to the online payment processor which coordinates the actual transfer of funds between each funder's and fundee's accounts at their respective financial institutions. Through this same aspect of this embodiment, the trackability feature of the invention can be carried out. Additionally, through this same communication aspect of the embodiment, the facilitating entity can arrange for service payments to be made to its bank account from the funders and fundees in exchange for facilitation of the relationship between the parties to the transaction.

The invention utilizes a financial mechanism for the fundee to access the funds as a payment mechanism along with the options to disburse funds through electronic transactions. As stated above, the financial mechanism can include a device that can readily communicate the funder or fundee's transactional instructions to the various account managing entities which can include the banks, payment processor, and facilitating entity. The financial mechanism can include, but is not limited financial networks accessed through cell/mobile phones, personal computers, or other electronic devices capable of such communications.

These and other aspects, features and advantages can be combined together and further appreciated from the accompanying description of the embodiments and drawings.

This invention is largely based upon the combination and application of several existing principles in microlending, finance, social networking, information technology, Internet technology, payment processing technology, and telephony. There is an opportunity to improve informal modes of financing by applying new paradigms (such as social networking) and technology (such as computers, Internet, and cell phones).

The various aspects and embodiment are applicable to a wide variety of financial services. Such services may include, but are not limited to, management of fundraising, loans, and investments.

### BRIEF DESCRIPTION OF THE DRAWINGS

The above and other objects will be apparent upon consideration of the following detailed descriptions, taken in conjunction with the accompanying drawings, in which like reference numerals refer to like parts throughout, and in which:

FIG. 1 illustrates a system for initiating a fundraising transaction.

FIG. 2 illustrates a system for facilitating online viewing of purchases.

FIG. 3 illustrates a system for facilitating a loan repayment transaction.

FIG. 4 illustrates a system for facilitating a financial fund transfer transaction.

FIG. 5 illustrates a flow chart of a method for facilitating funding of loans over a communication network.

FIG. 6 illustrates a flow chart of a method for providing spending transactions related to a funding amount to contributors.

FIG. 7 illustrates a flow chart for facilitating a scheduled repayment of a loan amount to funders.

### DETAILED DESCRIPTION

Aspects and embodiments now will be described more fully hereinafter with reference to the accompanying drawings in which illustrative embodiments are shown. This invention may, however, be embodied in many different forms and should not be construed as limited to the embodiments set forth herein; rather, these embodiments are provided so that this disclosure will be more thorough, and will help convey the scope of the invention to those skilled in the art. Aspects may be embodied as a method, financial management system, or computer program product. Furthermore, aspects of the invention may be targeted for use by individuals and groups, consumers and businesses.

In the following description of the preferred embodiment, reference is made to the accompanying figures that form a part hereof. It is to be understood that while the example of a borrower, lender and loan is used, other embodiments for the fundee, funder and type of funding may be utilized without departing from the scope of the present invention.

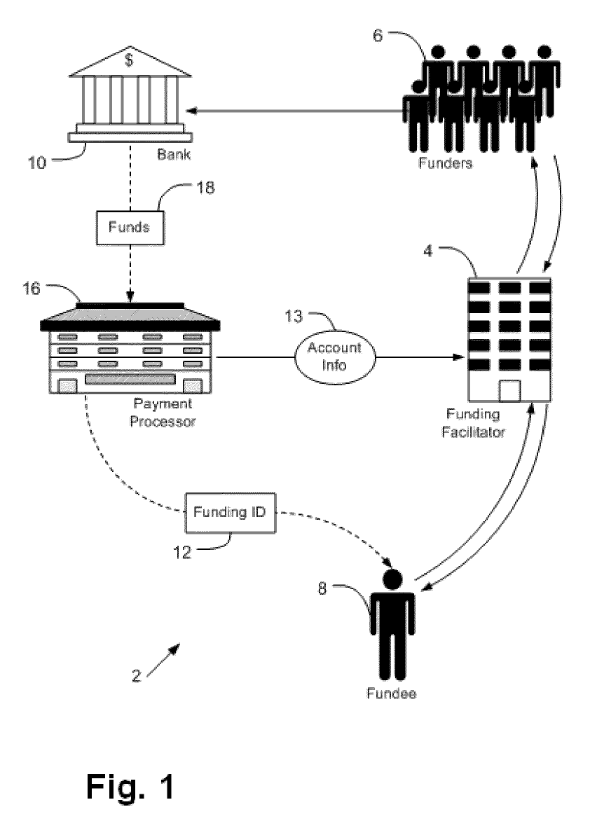

Referring to FIG. 1, the figure illustrates a system 2 for initiating a transaction using funds raised in a fundraising transaction. Funding facilitator 4 operates a method accessible over a communications network 5 that facilitates donors, investors, or lenders, 6 giving, investing or lending, money to a fundee 8 via the network. Facilitator 4 may generate a web page, for example, that funders 6 view and use to make donations, or loans. Facilitator 4 provides an interface that allows funders 6 in transferring funds from a personal checking account, for example, to a business checking account associated with fundee 8 at bank 10. Furthermore, funds are linked to a funding identifier 12 issued by payment processor 16 to fundee 8, and account information 13 is communicated from processor 16 to facilitator 4. Account information 13 may include, but is not limited to, an account number linked to the business checking account, amount of funds in the account, and contact information of the funders.

In addition, the interface provided by facilitator 4 may impose rules or restrictions on using funds. For example, fundee 8 or funder 6 may impose a maximum transaction amount so that the fundee 8 may not make a single purchase or withdrawal that exceeds the maximum transaction amount.

When fundee 8 withdraws funds from the business account to pay a vendor 11, for example, he may use the funding identifier 12 issued by payment processor 16. When fundee 8 uses funding identifier 12, payment processor 16 conducts the transfer of funds 18 from bank 10 to vendor 11 according known methods, such as, for example, electronic funds transfer (EFT). In addition, funding identifier 12 may be used to facilitate multiple forms of payment that processor 16 can handle, including online payment via computer, payment via credit card, payment via mobile financial network, or wire transfer.

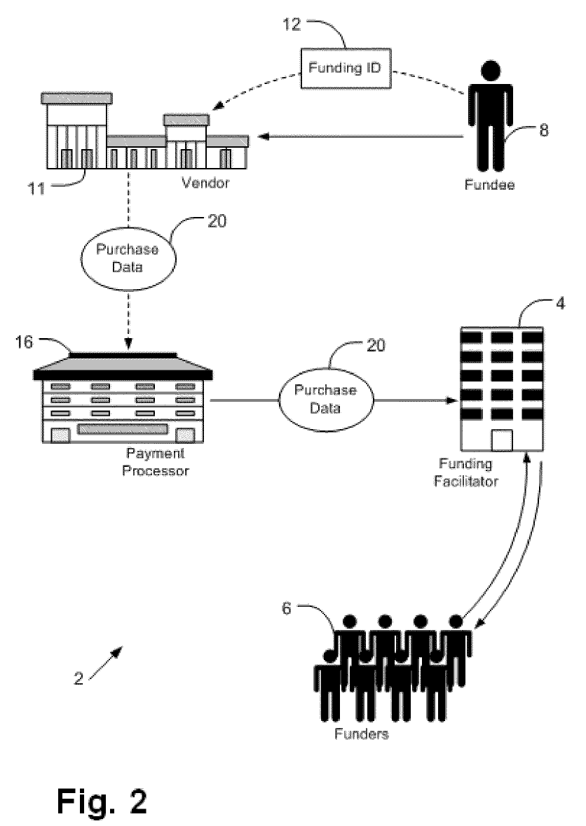

Turning now to FIG. 2, an aspect of system 2 is shown. When fundee 8 uses raised funding amount to purchase a good, or service, from vendor 11 using funding identifier 12, the vendor sends purchase data to payment processor 16. Payment processor can generate a payment request message to withdraw money from the financial institution associated with the funding identifier 12. In addition, payment processor 16 forwards the purchase data 20 to funding facilitator 4. A server at facilitator 4 receives purchase data 20 and makes it accessible via a web site. To access the website, any of the funders 6 can enter login information associated with them that grants them access to information regarding the account that holds the money they provided to fundee 8, as shown in FIG. 9. Thus, at any time, funders 6 may view deposit and withdrawal activity of the account they contributed money to.

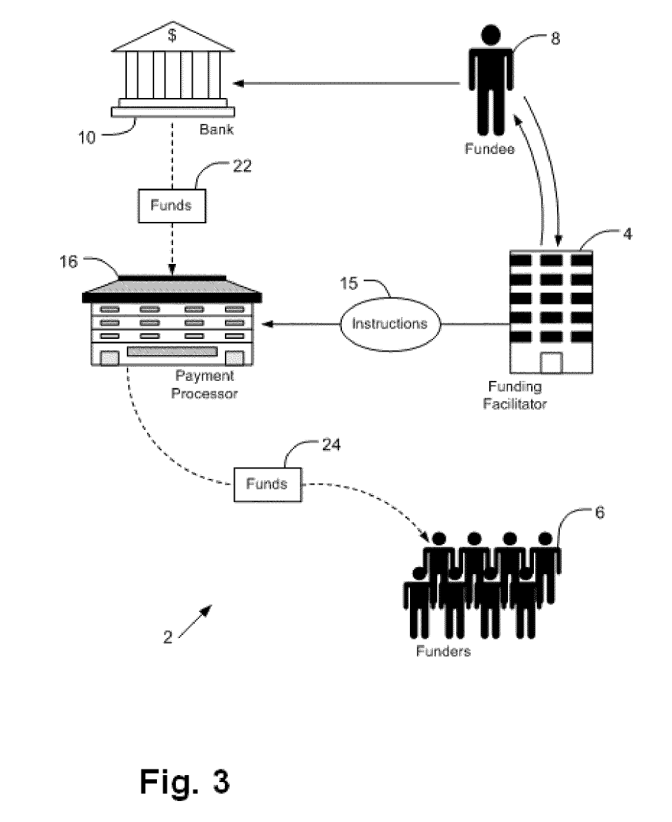

Turning now to FIG. 3, the figure illustrates an aspect of system 2 wherein fundee 8 repays, some, or all of, a funding amount that is a loan. Using an interface, such as an internet web page in a browser operated from funding facilitator 4, the authenticated fundee 8 makes a payment to a checking account at bank 10. In response to instructions 15 received from facilitator 4, payment processor 16 transfers repayment funds 22 from bank 10 in the form of an electronic payment, and distributes funds 24 to the bank account, or bank accounts, of the one, or more, funders 6. Payment processor makes the repayments according to proportions contained in the instructions 15. For example, if one person donated $12,000, another lent $20,000, a third lent $10,000 and a fourth invested $50,000 in exchange for stock, a repayment message from facilitator 4 corresponding to repaying $6,000, would apportion $4,000 to the second person and $2,000 to the third. The first person would not receive a repayment, since he donated $12,000. The fourth would not receive a portion of repayment funds 24 either because he received stock in exchange for his contribution. Thus, the instructions 15 from facilitator 4 in response to fundee 8 entering a repayment amount of $6,000 using a web page served from the funding facilitator would instruct payment processor 16 to generate a funds transfer to account numbers of accounts associated with the second and third persons 6 who loaned money.

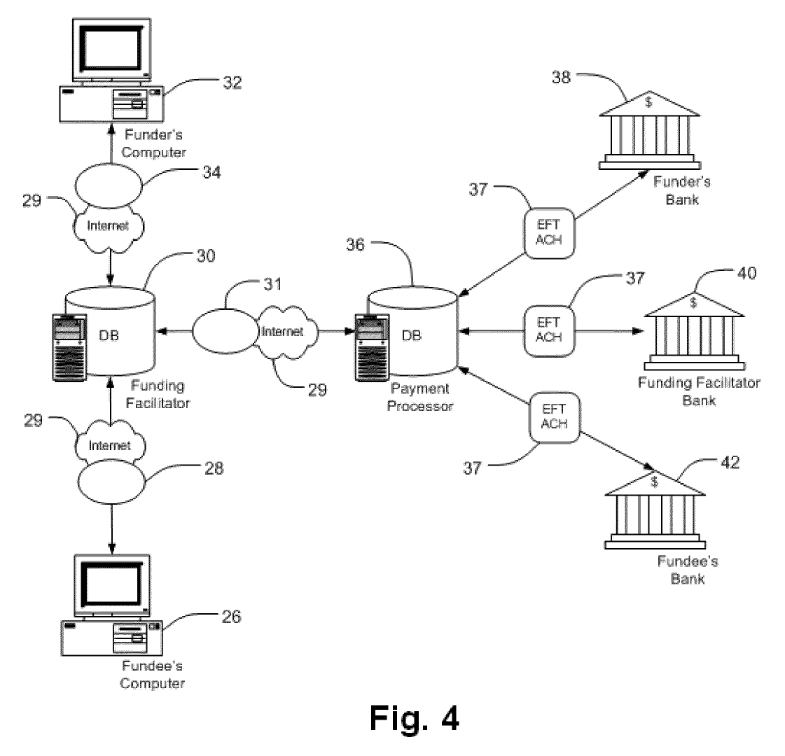

Turning now to FIG. 4, the figure illustrates an embodiment of system 2 showing how account data and funds data travel between the various entities with the funding facilitator 4 as intermediary. In the illustrated embodiment, fundee 8 uses his computer 26 to login and send, or receive, an account data message 28 over a communication network, such as, for example, the Internet, to, or from, the funding facilitator's database 30. The data message in this case may contain a funding request that the fundee posts on a website that invites his friends and family to provide funding for his business.

A funder 6 uses his funder computer 32 to login and send, or receive, an account information message 34 over the communication network to, or from, the funding facilitator's database 30. Account information message 34 may contain a funding request that funder 6 views, and then options that the funder selects from the website in order to provide funding and terms of the funding. For example, a funder 6 may select from providing funding as a loan, a donation, or an investment.

The funding facilitator's database 30 can communicate with the fundee's and funders' computers 26 and 32, respectively, via the Internet, for example sending a funder a data message regarding purchases that the fundee has made. The funding facilitator's server, and database 30 can send the fundee an email reminder, or notification, when a loan payment is due.

The funding facilitator's server, and database, 30 also communicates with the payment processor's 16 server, and database, 36, sending and receive data 31 via a file transfer protocol (“FTP”) data import from the one database to the next. For example, the funding facilitator server/database 30 can import a data log, or report, containing a list of purchases made in one week using the fundee's account, or funding identifier. The report of purchases may also include purchases made by all fundees who use the funding facilitator 4.

The payment processor's server/database 36 may receive, or import, a data message from the funding facilitator 4 in the form of instructions regarding which accounts should be debited or credited and by how much. For example, payment processor server/database 36 may import data from the funding facilitator server/database 30 regarding how much to pay each funder when the fundee makes a loan payment. The amounts may be paid to various funders in proportion to the amounts loaned, as described elsewhere herein.

Payment processor server/database 36 communicates with banks in order to send, or receive funds, via electronic funds transfer—automated clearinghouse (EFT-ACH). In the case of a loan, server/database 36 may generate an EFT-ACH transaction message 37 that debits funds from a funder's bank account at bank 38, places a five percent (for example) commission from the debited funds in the funding facilitator's bank account at bank 40 as a service fee, and then credits the remaining funds to fundee's account at fundee's bank 42. Alternatively, in case of a loan in repayment, server/database 36 may communicate the appropriate account numbers to banks 38, 40, and 42, and withdraw funds from fundee's bank 42, place a two percent (for example) service fee, or commission, in the funding facilitator's bank 40 bank account, and then deposit the remaining funds to funder's bank account at bank 38. Finally, payment processor server/database 36 relays a repayment transaction message containing information regarding the repayment to funding facilitator's server/database 30 during the next FTP data import.

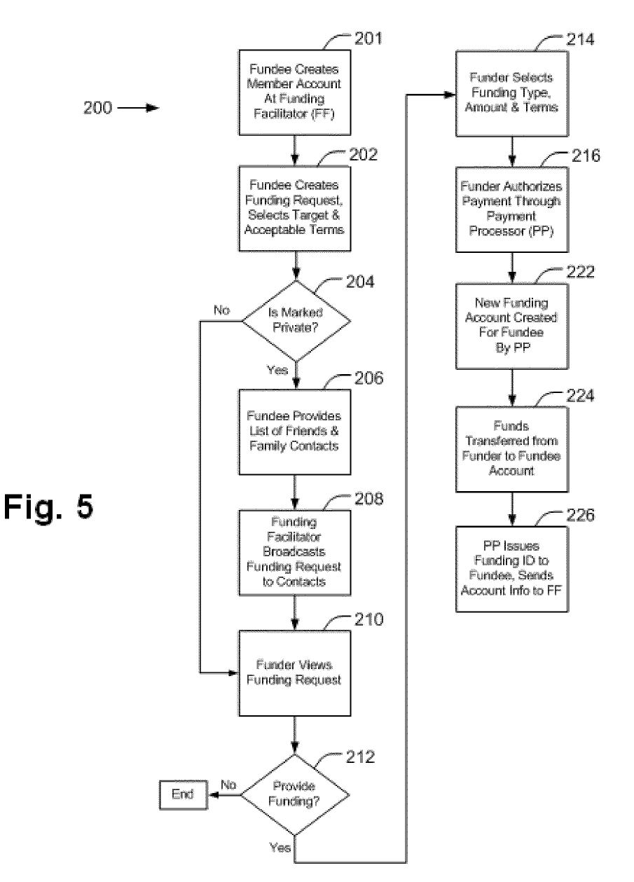

Turning now to FIG. 5, a flow chart illustrates a method 200 for creating a funding request, receiving funding, using the funding to operate a business venture, and for repaying the funding amounts. At step 201, a fundee creates a fundee's member account at a funding facilitator. A funding facilitator typically operates an internet server that hosts a web site with web pages that facilitate the various aspects of receiving funding, establishing checking accounts with financial institutions based on the funding identifier associated with the funding amount, or loan amount, and facilitating repayment of a loan amount.

At step 202 a fundee creates a funding request. The funding request may include, but is not limited to, a target funding amount, terms for funders contributing to the funding amount, length/period of funding, purpose of the funding request (e.g., type of business, or undertaking, and uses the fundee will make of the funding amount). The funding request may also include a flag that the funding request will not be publicly available.

At step 204, software running on the funding facilitator server determines whether the funding request has been flagged as private. If yes, the funding facilitator software prompts a fundee to enter a list at step 206 of potential funders (donors, lenders, investors, etc.), along with electronic identifiers, such as, for example, e-mail addresses, SMS identifiers, social networking profile names, instant messenger screen names, and the like. At step 208, the funding facilitator transmits the funding request, including the information described above in connection with step 202, to the electronic identifiers described above in reference to step 206. At step 210, recipients of the funding request transmissions view the funding request information. Returning to the description of step 204, if fundee did not flag the funding request as private, method 200 advances to step 210 in which the funder is unknown to the fundee prior to using the funding facilitator.

After step 210, a potential funder decides at step 212 whether to provide funding according to the funding request. If the potential funder decides not to provide funding in response to the request, method 200 ends. If at step 212 the potential funder decides to provide funding according to the funding request, method 200 advances to step 214 where the funder selects a funding type he wishes to use. The type could be a loan, a donation/gift, or an investment by the purchase of stock.

At step 216, using the software hosted by the funding facilitator server, the funder authorizes payment from the funder's financial institution account. The funding facilitator software facilitates the funds transfer by initiating an electronic payment from the source financial institution and account to the target institution and account through a payment processor.

At step 222 the funding facilitator transmits a message to a payment processor to create an account for the fundee. At step 224, the software hosted by the funding facilitator initiates a message that transfer funds from the funder to the fundee's account managed by the payment processor. At step 226 the payment processor issues a funding identifier to the fundee. In addition, the payment processor transmits the account information associated with the funding identifier and the fundee's account to the funding facilitator, that updates a memory on its server by storing the account information to a memory and associating the funding identifier with the fundee's account with the funding facilitator.

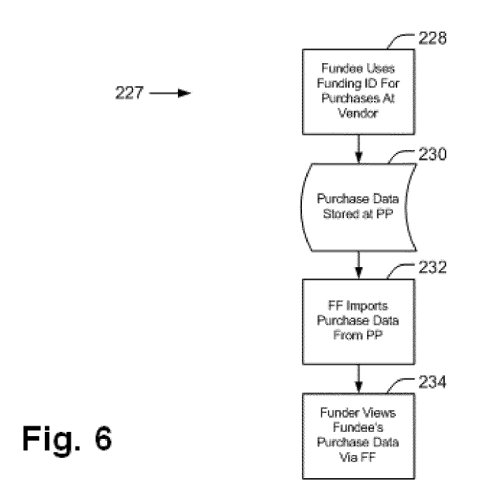

Turning now to FIG. 6, the figure illustrates a flow chart of a method 227 for a fundee using a funding identifier and for informing a funder of transactions a fundee makes. At step 228 the fundee uses a funding identifier to purchase goods or services from a vendor. At step 230, purchase information from the point of sale is stored at a payment processor. At step 232 software running on a funding facilitator imports information from the payment processor. Typically, the funding facilitator queries the payment processor periodically for any transaction information new since the last query. Alternatively, the payment processor can periodically push information to the funding facilitator server. At step 234, a funder logs in to the web site hosted by the funding facilitator using account and log in information previously associated with the funder (the login and account information is typically established at the time a funder decides to add to a funding amount, such as when the funder authorizes payment to the payment processor at step 216 referenced in FIG. 5), in order to view information regarding purchases/transactions the fundee has made using the funding identifier.

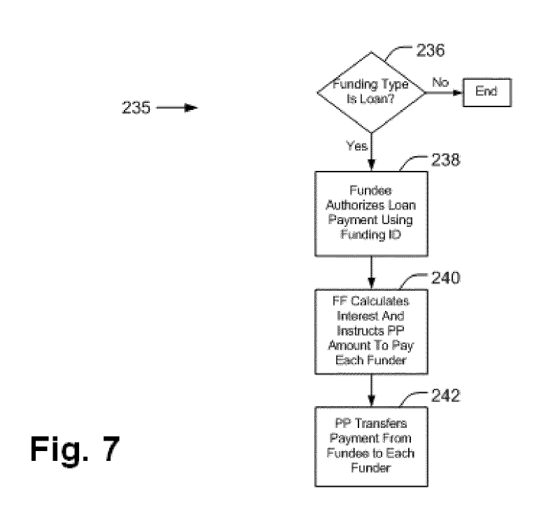

Turning now to FIG. 7, the figure shows a flow chart illustrating a method 235 for repaying a loan amount to a funder. At step 236 software hosted by a funding facilitator determines whether a funder who has logged into the funding facilitator website using his login information is a lender. The funding facilitator software determines this based on the login information provided by the funder. If the funder is not a lender (i.e. funder is a donor or an investor) method 235 ends. If the software running on the funding facilitator server determines that the funder is a lender, the fundee authorizes at step 238 monthly loan repayment from an account of the fundee to the funding facilitator based on the account number associated with the funding request at step 201 in FIG. 5. Typically, the fundee will establish a repayment schedule at step 202, but may override a repayment schedule if he does not have enough money to honor the initial repayment schedule. However, funders can monitor spending habits of the fundee using the steps illustrated in FIG. 6, and if one, or more, funders determine that the spending habits of the fundee are poor, they can login to the software hosted by the funding facilitator and request immediate repayment, or restrict spending if certain conditions occur. Such conditions could include, for example, missing a scheduled repayment, or allowing the amount associated with the funding identifier to drop below a predetermined amount before a predetermined date. These conditions may be established by the fundee at step 202 in the funding request to entice funders to lend.

Returning to FIG. 7, at step 240, the funding facilitator calculates interest due on the loan and adds it to the amount to be repaid to each funder. At step 242, the payment processor initiates an electronic payment that transfers funds from an account of the fundee to each of the funders according to a predetermined schedule and proportion.

What is claimed, is:

1. A method for configuring a payment processor computer system to facilitate a funding transaction affecting a funding amount linked to a bank account, comprising:
associating a funding amount identifier that corresponds to the funding amount with each one of one, or more, funder's account numbers;
receiving a transaction message that includes information related to the transaction;
storing the information related to the transaction to a memory of the payment processor computer system;
receiving a request to review transactions associated with the funding amount identifier from one of the funders; and
granting access over the communication network to the requesting funder.

2. The method of claim 1 wherein the funding amount identifier is an account number with the payment processor.

3. The method of claim 1 wherein the funding amount identifier is a bank account number.

4. The method of claim 3 wherein the bank account is a checking account.

5. The method of claim 1 further comprising:
receiving an additional funding amount message over the communication network;
increasing the funding amount by the additional funding amount indicated in the additional funding amount message; and
wherein the additional funding amount message includes a funder financial institution account number associated with a funder's account with a financial institution and wherein the payment processor computer system generates a transaction message that causes a transfer of funds from the funder's account with the funder's financial institution to the funding amount according to the funding amount identifier.

6. The method of claim 1 further comprising:
generating a repayment message that includes a funder financial institution account number associated with a funder's account with a financial institution of the funder, the loan identifier, and an amount;
transmitting the repayment message over the communication network to the financial institution of the funder associated with the funder's account; and
wherein the message includes an instruction to transfer the amount contained in the repayment message from the funding amount associated with the funding amount identifier to the account associated with the funder's account with a financial institution of the funder.

7. The method of claim 6 wherein the repayment message includes multiple micro repayment messages directed to a some, or all, of the funders, wherein the amount in each of the micro repayment messages is proportionate with respect to the amounts in the other micro repayment messages according to the proportionate amount each of the corresponding some, or all, funders contributed to the funding amount.

8. A method for configuring a funding facilitator computer system to notify, over a communication network, one, or more, of a plurality of funders of a transaction affecting a funding amount linked to a bank account, comprising:
associating each one of the funders' account numbers with login information of each respective funder;
associating a funding amount identifier that corresponds to the funding amount with each one of the one, or more, funder account numbers;
receiving a transaction message from a payment processor computer system, wherein the transaction message includes information related to the transaction;
storing the information related to the transaction to a memory of the funding facilitator computer system;
receiving a request to review transactions associated with the funding amount identifier, wherein the request includes a funder account number and login information of the one of the funders; and
granting access over the communication network to the funder corresponding to the login information contained in the request to review the transaction.

9. The method of claim 8 wherein the funding amount identifier is an account number with a payment processor.

10. The method of claim 8 wherein the funding amount identifier is a bank account number.

11. The method of claim 10 wherein the bank account is a checking account.

12. The method of claim 8 further comprising:
receiving an additional funding amount message over the communication network;
increasing the funding amount by the additional funding amount indicated in the additional funding amount message; and
wherein the additional funding amount message includes a funder financial institution account number associated with a funder's account with a financial institution and wherein the funding facilitator computer system generates a transaction message that causes a payment processor computer system to transfer funds from the funder's account with the financial institution to the funding amount according to the funding amount identifier.

13. The method of claim 8 further comprising:
generating a repayment message that includes a funder financial institution account number associated with a funder's account with a financial institution of the funder, the loan identifier, and an amount;
transmitting the repayment message over the communication network to the financial institution of the funder associated with the funder's account; and
wherein the message includes an instruction to transfer the amount contained in the repayment message from the funding amount associated with the funding amount identifier to the account associated with the funder's account with a financial institution of the funder.

14. The method of claim 13 wherein the repayment message includes multiple micro repayment messages directed to a some, or all, of the funders, wherein the amount in each of the micro repayment messages is proportionate with respect to the amounts in the other micro repayment messages according to the proportionate amount each of the corresponding some, or all, funders contributed to the funding amount.
